(19) United States
(12) Patent Application Publication
(10) Pub. No.: US 2007/0049243 A1
(43) Pub. Date: Mar. 1, 2007

(54) Method and system for monitoring operation of a mobile telecommunications network

(76) Inventor: Juergen Voss, Wiesbaden (DE)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/217,721

(22) Filed: Sep. 1, 2005

(51) Int. Cl. H04M 11/00

(52) U.S. Cl. 455/405

(57) ABSTRACT

A method and system for monitoring operations of a mobile telecommunications network, which includes a multiplicity of different types of communications links for conveying communications data between end users, with each different type of communications link having a separate respective signaling information protocol, includes recording signaling information from each communications link in a database during routing of communications data through the telecommunications system, and generating a database report from recorded signaling information including end-to-end call statistics covering the communications links between end users and a count of successful and non successful calls by call type.

### FIELD OF THE INVENTION

The present invention generally relates to monitoring operation of mobile telecommunications networks, and in particular to collecting and analyzing signaling information from all network links.

### BACKGROUND OF THE INVENTION

The nature of mobile telecommunications systems is changing under the ever present influences of competition and improving technology. New digital services drive customer demand and mobile service providers are transitioning to faster digital networks to increase their bandwidth capacity while reducing bandwidth costs. Of course, these transitions have the added burden of maintaining or even improving current service levels during the transitional steps.

The original digital mobile networks focused on voice transmissions. Then, low bandwidth digital services such as text messages and e-mail were added. Currently, systems are being upgraded for high bandwidth multimedia applications. Throughout this transition, service providers need to maintain the same service availability and service quality that their customers have come to expect, or risk losing market share.

FIGS. 1 and 2 are an example of the evolution of one such GSM mobile network from a circuit switched voice system to a packet switched multimedia network. FIG. 1 shows a network 10, which has been upgraded from a circuit switched voice network with the addition of packet data transmission capability. The original network connected to a Public Switched Telephone Network (PSTN) 12, and included a plurality of Mobile Switching Centers (MSC) 14 which routed calls throughout a Base Station Controller (BSC) 16 and a Base Transmission Station (BTS) 18 to wireless mobile devices 20. Roaming users are accommodated by recording their presence in an (HLR) 22.

General Packet Radio Service (GPRS) was added to the original network by means of a (GGSM) 24 which made direct connection to a packet data network (PDW) 25. Packet data is coupled to BSC 16 through a Serving GPRS Support Node (SGSM) 26. This overlay data network effectively increased the bandwidth of the core network to allow high speed data transfer with an ‘always on’ connection. The restricting factor for end-to-end speech data transfers became the radio access network.

FIG. 2 shows the next step of transition with the addition of a high speed wireless interface in the form of wide band code division multiple access (WCDMA). This new interface includes a multiplicity of secondary transmission nodes 30 (known as Node B), which are typically co-located on existing BTS 18 towers. Signals are coupled to secondary nodes 30 through Radio Network Controllers (RNC) 32 which can handle more than one secondary node 30. Co-location of secondary nodes 30 on BTS 18 is possible because secondary nodes 30 work in a higher frequency band.

It should be noted that each of the different inter nodal links used in the described networks has a different functionality and uses a different signaling protocol that is handled by each intervening node. These different protocols add complexity to the networks, which makes fault analysis very difficult. For this reason, signaling analyzers have been developed to record the various signaling information in a database to thereby allow careful analysis of the cause of communications problems.

These upgraded mobile networks require exceptional troubleshooting capability for the many different network links and signaling protocols.

### SUMMARY OF THE INVENTION

Accordingly, one embodiment of the present invention covers a method for monitoring operations of a mobile telecommunications network, which includes a multiplicity of different types of communications links for conveying communications data between end users, with each different type of communications link having a separate respective signaling information protocol, comprising the steps of: recording signaling information from each communications link in a database during routing of communications data through the telecommunications system; and generating a database report from recorded signaling information including end-to-end call statistics covering the communications links between end users and a count of successful and non successful calls by call type.

The step of recording may include the step of grouping the signaling information for circuit switched protocols and wireless communications link protocols in separate relational databases. The step of generating a database report may include the step of producing a count of communications link attachments and detachments made. The step of generating a database report may include the step of producing a count of unanswered paging requests. The step of generating a database report may include the step of calculating system key performance indicators from the recorded signaling information.

The step of generating a database report may include the step of identifying a root cause of failure for unsuccessful calls from the recorded signaling information. The step of generating a database report may include the step of calculating statistics from identified root causes of failure. The step of generating a database report may include counting failed calls that have a telecommunications system failure reason as well as a non-telecommunications system failure reason. The step of calculating statistics from identified root causes of failure may separate types of calls which may include circuit switched voice calls, circuit switched data calls, packet switched calls, short message service calls, and multimedia message service calls.

Another embodiment of the present invention covers a telecommunications system adapted to monitor routing of communications including data and corresponding signaling information, between end users, comprising: a mobile telecommunications network having a multiplicity of different types of communications links interconnected between different types of nodes, wherein each different type of communications link has a separate respective signaling protocol for conveying the communications data between the nodes; a database adapted for recording signaling information from each communications link during the routing of communications through the telecommunications system; and a database report generated from recorded signaling information and adapted to provide end-to-end call statistics covering all communications links between end users and including a count of successful and non successful calls by call type.

The database report may include a count of communications link attachments and detachments made. The database report may include a count of unanswered paging requests. The database report may include a count of calls attempted. The database report may be adapted to calculate system performance from the recorded signaling information.

The database report may be adapted to identify the root cause of failure for unsuccessful calls from the recorded signaling information. The database report may be adapted to calculate statistics from identified root causes of failure. The system performance may be calculated respective of call type relative to all protocol layers. The system may further comprise a root cause of failure database report covering all communications links between end users and indicating the root cause of failure over all signaling protocols. The root cause of failure report may separate types of calls which may include circuit switched voice calls, circuit switched data calls, packet switched calls, short message service calls, and multimedia message service calls.

The root cause of failure report may indicate numbers of calls failing due to a user being unknown in an HLR or due to radio link failure. The root cause of failure report may be adapted to calculate key performance indicators as defined by telecommunications industry standards.

### BRIEF DESCRIPTION OF THE DRAWINGS

The present invention is illustratively shown and described in reference to the accompanying drawings, in which:

FIG. 1 is a block diagram of a prior art GSM mobile telecommunications system having GPRS data network upgrade;

FIG. 2 is a block diagram of a prior art GSM mobile telecommunications system which has been upgraded with the addition of a wideband code division multiple access air interface;

FIG. 3 is a representational diagram of a mobile telecommunications network having a system for monitoring routing of communications, constructed in accordance with the present invention; and

FIG. 4. shows a report constructed in accordance with the present invention.

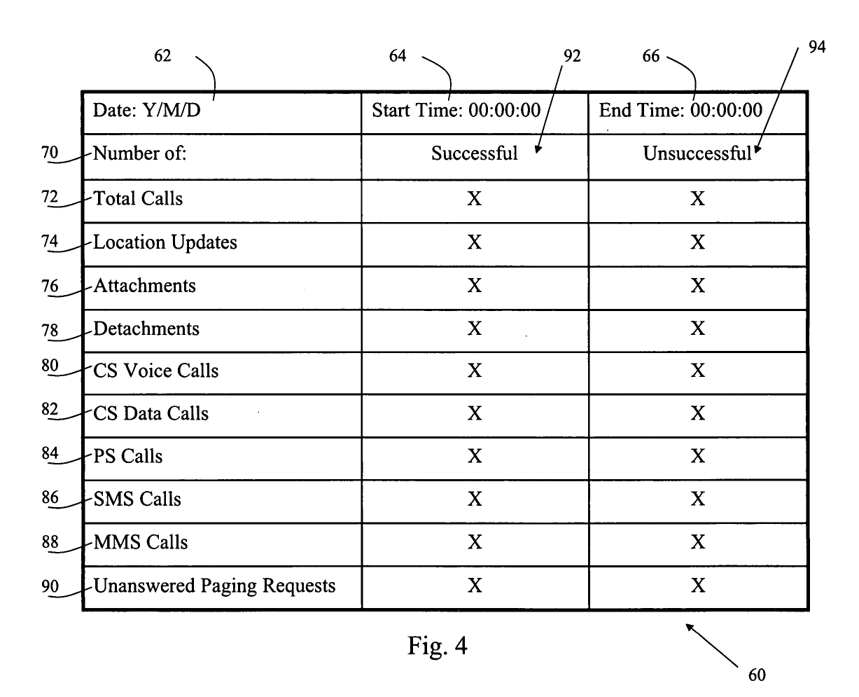

### DETAILED DESCRIPTION OF THE DRAWINGS

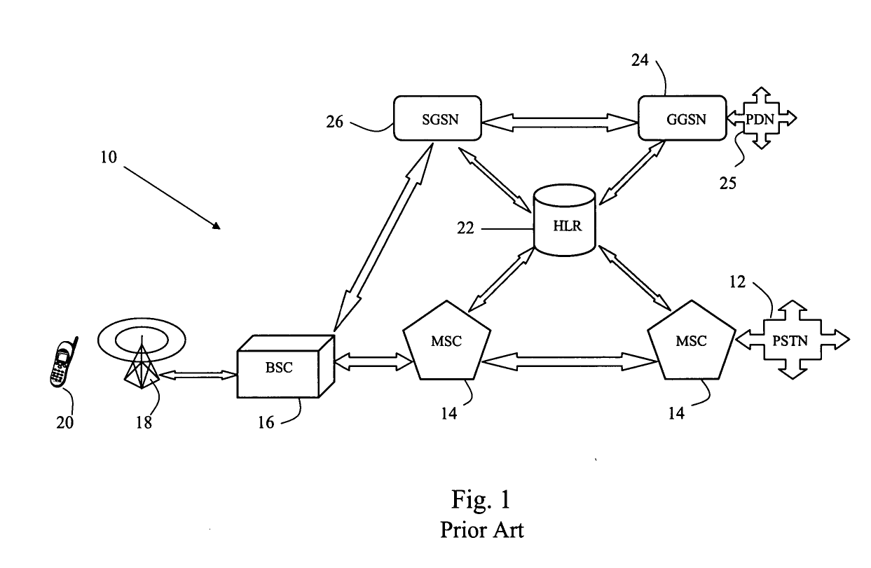

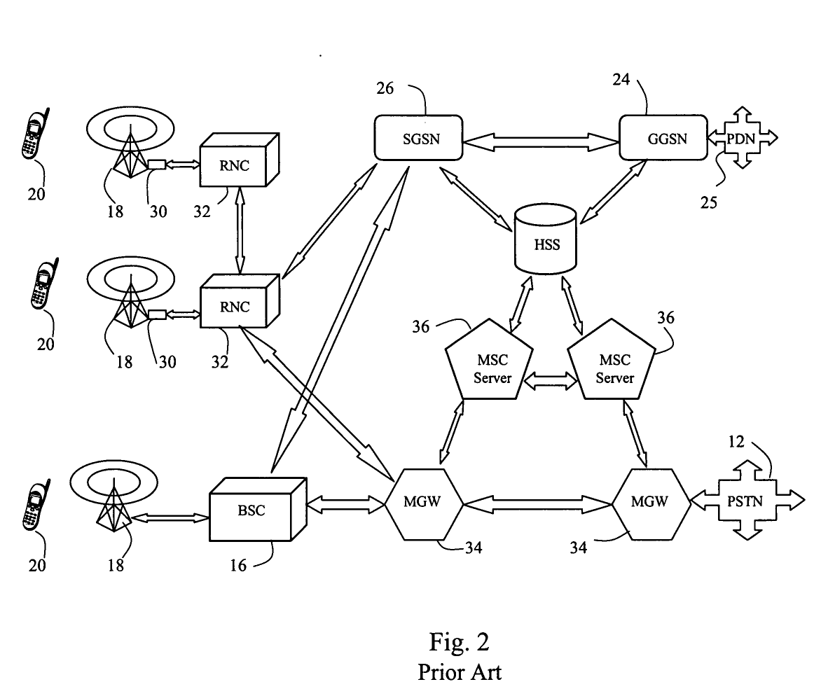

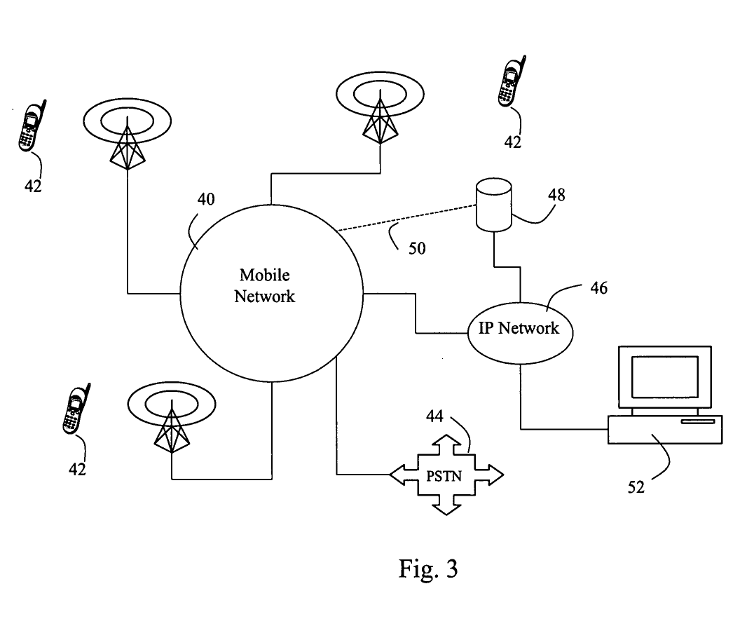

FIG. 3 shows a mobile telecommunications network 40 coupled to rout communications between separate end users 42 and a PSTN 44. Network 40 is also coupled to an Internet Protocol (IP) Network 46, which is linked to a database 48. Mobile network 40 is constructed in any suitable manner similar to the prior art described in reference to FIGS. 1 and 2. Mobile network 40 is further adapted to collect the signaling information used to rout data through network 40 and to transmit it to database 48 for recording therein. Database 48 may be so linked to network 40 in any suitable manner, including a more direct connection 20, which bypasses IP network 46.

Database 48 may be accessed in any suitable manner, such as through IP network 46 by a computer terminal 52, for accessing and analyzing the recorded signaling information. A suitable database application may reside either in database 48 or terminal 52 for analyzing the signaling information in database 48. Such a database application may be constructed in any suitable manner known in the art.

The database application is used to generate a report 60 from the signaling information stored in database 48. Report 60 includes a Date 62, Start Time 64 and End Time 66 for the signaling information used to compile the report. Report 60 tabulates the signaling information in terms of the number of calls 70 and counts those calls by the categories of Total Number 72, Location Updates 74, Attachments 76, Detachments 78, Circuit Switched (CS) voice calls 80, Circuit Switched (CS) data calls 82, Packet Switched (PS) calls 84, Short Message Service (SMS) calls 86, Multimedia Message Service (MMS) calls 88 and Unanswered Paging Requests 90. Each of the categories 72-88 is broken down between successful calls 92 and unsuccessful calls 94. This success count is based upon end-to-end success rates and all of the links in between. For example, unsuccessful calls may have multiple failure reasons, such as a CC cause of “user busy, or a RANAP cause of “Request Radio Resources not available” or a NBAP cause of “synchronization lost”. The categories 72-88 may further be broken down to different quality class and data rates.

The above tabulation of unsuccessful calls may further be broken down as a tabulation of the root cause of failure. Each category 72-88 would be divided up by the various failure causes and the signaling information would be reviewed to identify the root cause of failure for each unsuccessful call so that each root cause can be counted accordingly.

The tabulated data may be used to calculate any variety of key performance indicators, including, but not limited to: service accessibility, setup time, speech quality and service retainability for telephony; service accessibility and service integrity for short message service; and service accessibility and retainability for multimedia message service.

In telephony, service accessibility is determined as the probability that an end user can access mobile telephony service when requested, once network access is available.

Service accessibility may optionally be determined in this manner within the stricter confines of specified tolerances and other given operating conditions.

The setup time in telephony is determined as the time between the sending of complete address information and receipt of a call setup notification. Optionally, setup time may be determined within the qualification of specific tolerances and other given operating conditions.

Speech quality may also be termed service integrity and is an indicator representing the quantification of end-to-end speech transmission quality on a per call basis.

Service retainability may also be determined as a call completion ratio or the probability that a service, once obtained, will continue to be provided under given conditions for a given time duration.

For Short Message Service (SMS), service accessibility is determined as the probability that the end user can access the service once network access is present. Service accessibility may also include a quality of service indicator in terms of access delay. This is determined as the time between sending a short message to an SMS center and receiving an acknowledgment from the SMS center.

For SMS, service integrity may be determined as an end-to-end delivery time and as a completion ratio. The end-to-end delivery time may be determined as the time between sending a short message to an SMS center and receiving the short message at a target mobile device. This presumes that a target mobile device is ready to receive. The completion ratio may be determined as the probability that the SMS messages will be delivered to the target destination under the given conditions, again assuming that the receiving target is ready to receive.

For Multimedia Message Service (MMS), service accessibility is calculated in terms of a send failure ratio, a send time, a retrieval failure ratio, and a retrieval time. An MMS failure ratio describes the probability that an MMS message cannot be sent by a subscriber although its is requested by pressing the send button. The MMS send time is the time elapsing from pressing the send button to the completion of the data transfer.

The MMS delivery failure ratio describes the probability that the MMS message cannot be down loaded by the mobile unit, which unit has previously received an MMS notification. The MMS retrieval time is the completion time of a download once the necessary network signaling is completed with the target mobile device.

In MMS, service retainability is determine by a notification failure ratio, a notification time, an end-to-end failure ratio, and an end-to-end delivery time. The notification failure ratio describes the probability that the MMS is not able to deliver notification of an MMS message to a target mobile device. The notification time is the time elapsing from the complete submission of the multimedia message to an MMS center to the reception of the notification by target mobile device.

The MMS end-to-end failure ratio describes the probability that the MMS is unable to deliver an MMS message after the send button is pushed or the sending party has not received an acknowledgement of the successful transmission. The MMS delivery time is the time elapsing from the pushing of the send button to the reception of the multimedia message by the target mobile device. This delivery time is not calculated if the message originating party has not received an acknowledgement of the successful transmission by the MMS center. Because the size of a multimedia message varies significantly, compared to an SMS message, message size can have a considerable impact on the submission time. For this reason, a typical sized multimedia message is used for making this measurement.

Common to all of the available services is the performance factor of network access, which depends a great deal upon wireless transmission factors in every location. A network access indicator may be more than just a signal strength indicator. It may act as a gate keeper to determine when to allow a user to select one of the available services. This determination can be based upon the statistical significance that a service can be used at a given confidence level. The network access indicator on a mobile device may also distinguish between circuit switched and packet switched networks. Network accessibility may be calculated as a probability that the mobile services are offered to an end customer by display of the network indicator on the mobile device.

The present invention is illustratively described above in reference to the disclosed embodiments. Various modifications and changes may be made to the disclosed embodiments by persons skilled in the art without departing from the scope of the present invention as defined in the appended claims.

What is claimed is:

1. A method for monitoring operations of a mobile telecommunications network, which includes a multiplicity of different types of communications links for conveying communications data between end users, with each different type of communications link having a separate respective signaling information protocol:
recording signaling information from each communications link in a database during routing of communications data through the telecommunications system; and
generating a database report from recorded signaling information including end-to-end call statistics covering the communications links between end users and a count of successful and non successful calls by call type.

2. The method of claim 1, wherein said step of recording includes the step of grouping the signaling information for circuit switched protocols and wireless communications link protocols in separate relational databases.

3. The method of claim 1, wherein said step of generating a database report includes the step of producing a count of communications link attachments and detachments made.

4. The method of claim 1, wherein said step of generating a database report includes the step of producing a count of unanswered paging requests.

5. The method of claim 1, wherein said step of generating a database report includes the step of calculating system key performance indicators from the recorded signaling information.

6. The method of claim 1, wherein said step of generating a database report includes the step of identifying a root cause of failure for unsuccessful calls from the recorded signaling information.

7. The method of claim 6, wherein said step of generating a database report includes the step of calculating statistics from identified root causes of failure.

8. The method of claim 7, wherein said step of generating a database report includes counting failed calls that have a telecommunications system failure reason as well as a non-telecommunications system failure reason.

9. The method of claim 7, wherein said step of calculating statistics from identified root causes of failure separates types of calls which may include circuit switched voice calls, circuit switched data calls, packet switched calls, short message service calls, and multimedia message service calls.

10. A telecommunications system adapted to monitor routing of communications including data and corresponding signaling information, between end users, comprising:
a mobile telecommunications network having a multiplicity of different types of communications links interconnected between different types of nodes,
wherein each different type of communications link has a separate respective signaling protocol for conveying said communications data between said nodes;
a database adapted for recording signaling information from each communications link during the routing of communications through said telecommunications system; and
a database report generated from recorded signaling information and adapted to provide end-to-end call statistics covering all communications links between end users and including a count of successful and non successful calls by call type.

11. The system of claim 10, wherein said database report includes a count of communications link attachments and detachments made.

12. The system of claim 10, wherein said database report includes a count of unanswered paging requests.

13. The system of claim 10, wherein said database report includes a count of calls attempted.

14. The system of claim 10, wherein said database report is adapted to calculate system performance from the recorded signaling information.

15. The system of claim 10, wherein said database report is adapted to identify the root cause of failure for unsuccessful calls from the recorded signaling information.

16. The system of claim 15, wherein said database report is adapted to calculate statistics from identified root causes of failure.

17. The system of claim 16, wherein system performance is calculated respective of call type relative to all protocol layers.

18. The system of claim 15, further comprising a root cause of failure database report covering all communications links between end users and indicating the root cause of failure over all signaling protocols.

19. The system of claim 18, wherein said root cause of failure report separates types of calls which may include circuit switched voice calls, circuit switched data calls, packet switched calls, short message service calls, and multimedia message service calls.

20. The system of claim 10, wherein said root cause of failure report indicates numbers of calls failing due to a user being unknown in an HLR or due to radio link failure.

21. The system of claim 10, wherein said root cause of failure report calculates key performance indicators as defined by telecommunications industry standards.
